(19) United States
(12) Patent Application Publication
(10) Pub. No.: US 2010/0051670 A1
(43) Pub. Date: Mar. 4, 2010

(54) Wire bonding device and wire bonding process using same

(75) Inventor: Yoshitsugu Okafuji, Kumamoto (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/461,552

(22) Filed: Aug. 14, 2009

(30) Foreign Application Priority Data
Aug. 26, 2008 (JP) 2008-216194

(51) Int. Cl. B23K 20/10; B23K 37/00

(52) U.S. Cl. 228/102; 228/1.1

(57) ABSTRACT

A wire bonding device conducts: detecting Z-axis moving speed of the capillary in a predetermined bonding position on a coupling terminal and controlling the Z-axis movement of the capillary by a moving mechanism if the Z-axis moving speed of the capillary is equal to or lower than a predetermined threshold; calculating a displacement in the Z-axis position after the Z-axis moving speed of the capillary reaches equal to or lower than the threshold on the basis of time-dependent change of the Z-axis position of the capillary; detecting a non-stick of the wire on the basis of a conducting condition between the wire and the coupling terminal, and judging whether a difference between the reference displacement and the displacement when a non-stick of the wire is detected by a non-stick detecting unit on the basis of the conducting condition is within a predetermined range or not; and correcting any one of the threshold and the oscillation output of the ultrasonic wave if a correction/judging unit judges with the non-stick detecting unit that a difference between the reference displacement and the displacement when a non-stick of the wire is detected is out of a predetermined range.

This application is based on Japanese patent application No. 2008-216194, the content of which is incorporated hereinto by reference.

### BACKGROUND

1. Technical Field

The present invention relates to a wire bonding device and a wire bonding process using same.

2. Related Art

Typical conventional wire bonding devices include, for example, Japanese Patent Laid-Open No. 2007-180348 and Japanese Patent Laid-Open No. 2007-142049.

A wire bonding device described in Japanese Patent Laid-Open No. 2007-180348 includes a unit for detecting a non-stick between a pad (coupling terminal) and a wire via an electric technique and a unit for detecting thereof via an optical technique. When a non-stick is detected via an electric technique and when the non-stick is also detected via an optical technique, a ball of a certain shape is formed again at the tip of the wire on the basis of the shape of the wire tip detected via the optical technique to carry out re-bonding for the pad.

A wire bonding device described in Japanese Patent Laid-Open No. 2007-142049 includes a bonding tool (capillary), an ultrasonic horn, which supports an end of the bonding tool and provides ultrasonic vibration to the bonding tool, and a vibration measurement unit, which measures vibration of the bonding tool to calculate a position of node in the vibration of the bonding tool. The wire bonding device provides a control for continuing or stopping a bonding operation based on the position of the node.

A detection of a non-stick via an electric technique with a conventional bonding device will be described in reference to FIG. 5. Once a bonding to a coupling terminal is successful, an energization condition is achieved between the wire and the coupling terminal. Thus, when the detected voltage is larger than a reference voltage (S901Y), the consecutive operation of the device is carried out to continue the implementation of the bonding process (S902). On the other hand, when non-stick is occurred between the wire and the coupling terminal, electric conduction is not achieved between the coupling terminal and the wire. Therefore, when the detected voltage is lower than a reference voltage (S901N), it is judged to be a non-stick, and then the device is automatically shut down to execute an error processing (S903). Then, the device is suitably adjusted by an operator to achieve a device recovery (S904).

### SUMMARY

However, the present inventor has recognized as follows. While the presence of the bonding non-stick can be detected in the conventional technology described in Japanese Patent Laid-Open No. 2007-180348 and Japanese Patent Laid-Open No. 2007-142049, a possible cause for the non-stick cannot be specified in such technology. Therefore, in some cases, the operation of the device must be stopped whenever a non-stick is detected, and the reason for the non-stick must be specified. Then, a certain time is required for adjusting the device, causing a problem of reduced throughput in the manufacturing process.

According to one aspect of the present invention, there is provided a wire bonding device, comprising: a capillary, containing a wire inserted therethrough; a moving mechanism for moving the capillary for X, Y, and Z directions; an ultrasonic wave-applying unit for oscillatively generating ultrasonic wave to apply ultrasonic vibration to the capillary; a movement control unit for detecting Z-axis moving speed of the capillary in a predetermined bonding position on a work, and then controlling Z-axis movement of the capillary with the moving mechanism when the Z-axis moving speed of the capillary is equal to or lower than a predetermined threshold; a Z-axis position detecting unit for detecting Z-axis position of the capillary in the bonding position; a calculating unit for calculating a displacement in the Z-axis position after the Z-axis moving speed obtained by the movement control unit reaches equal to or lower than the threshold on the basis of time-dependent change of the Z-axis position of the capillary; a storage unit for storing the displacement occurred when the wire is bonded to the workpiece, as a reference displacement; an electrical non-stick detecting unit for detecting a non-stick of the wire on the basis of a conducting condition between the wire and the workpiece; a judging unit for judging whether a difference between the reference displacement and the displacement when a non-stick of the wire is detected by the electrical non-stick detecting unit is within a predetermined range or not; and a correction unit for correcting any one of the threshold and the oscillation output of the ultrasonic wave if the judging unit judges that a difference between the reference displacement and the displacement when a non-stick of the wire is detected by the electrical non-stick detecting unit is out of a predetermined range.

According to another aspect of the present invention, there is provided a wire bonding process, including: inserting a wire in a capillary; moving the capillary for X, Y, and Z directions; oscillatively generating ultrasonic wave to apply ultrasonic vibration to the capillary; detecting Z-axis moving speed of the capillary in a predetermined bonding position on a workpiece and controlling the Z-axis movement of the capillary if the Z-axis moving speed of the capillary is equal to or lower than a predetermined threshold; detecting the Z-axis position of the capillary in the bonding position; calculating a displacement in the Z-axis position after the Z-axis moving speed of the capillary reaches equal to or lower than the threshold on the basis of time-dependent change of the Z-axis position of the capillary; storing the displacement occurred when the wire is bonded to the workpiece, as a reference displacement; detecting a non-stick of the wire on the basis of a conducting condition between the wire and the workpiece; judging whether a difference between the reference displacement and the displacement when a non-stick of the wire is detected on the basis of the conducting condition is within a predetermined range or not; and correcting any one of the threshold and the oscillation output of the ultrasonic wave if it is judged that a difference between the reference displacement and the displacement when a non-stick of the wire is detected is out of a predetermined range.

According to the present invention, the Z-axis position of the capillary is detected when the Z-axis movement of the capillary is controlled by the movement control section, and a non-stick of the wire is detected from the conducting condition between the wire and the workpiece. Then, a displacement in the Z-axis position is calculated on the basis of time-dependent change in the detected Z-axis position of the capillary, and it is judged whether the calculated the displacement is within a predetermined range for the reference displacement. This allows detecting a presence of a depression in the capillary due to the melting of the wire tip on the workpiece, in addition to detecting the conducting condition between the of wire and the workpiece. Therefore, it can be judged that no ultrasonic fusion is generated on the wire tip when no depression of capillary is detected, so that the correction unit is allowed to change the oscillation output of ultrasonic wave to provide an appropriate ultrasonic vibration to the capillary, thereby generating ultrasonic fusion in the wire tip. Further, the correction unit is allowed to change the threshold for the Z-axis moving speed, so that an appropriate contact of the wire on the workpiece can be achieved. Thus, even if a non-stick of a wire is detected via an electrical technique, the automatic correction of the device can be achieved, so that a trouble of a non-stick is quickly recovered, controlling a decrease in the throughput of the manufacturing process.

According to the present invention, a detection of a non-stick in a wire can be achieved with an improved accuracy to detect a cause of a wire non-stick. Therefore, an adjustment of a device can be promptly achieved without relying upon the skill of the operator, thereby controlling a decrease in the throughput of the manufacturing process.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a schematic diagram, illustrating a configuration of a wire bonding device according to an embodiment;

FIG. 2 is a schematic diagram, partially illustrating a configuration of the wire bonding device according to the embodiment;

FIG. 3 is a flow chart, showing a wire bonding process according to the embodiment;

FIG. 4 is a chart, showing monitoring data according to the embodiment; and

FIG. 5 is a flow chart, showing a conventional wire bonding process.

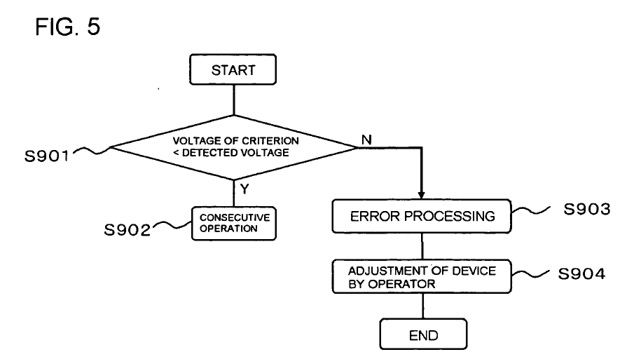

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposed.

Exemplary implementations according to the present invention will be described in detail as follows in reference to the annexed figures. In all figures, an identical numeral is assigned to an element commonly appeared in the figures, and the detailed description thereof will not be repeated.

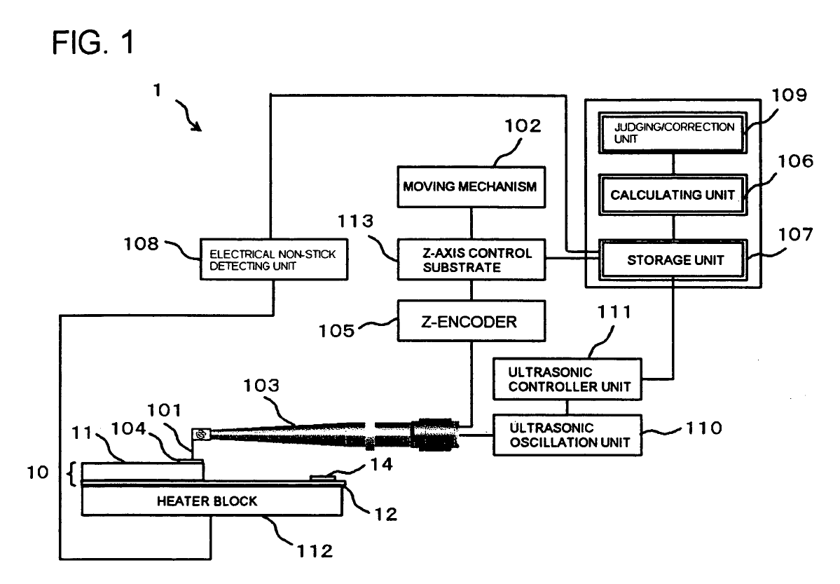

FIG. 1 shows a wire bonding device 1 of the present embodiment. The wire bonding device 1 includes a capillary 101 containing a wire inserted therethrough, a moving mechanism 102 for moving the capillary 101 for X, Y, and Z directions, an ultrasonic oscillation unit 110 for applying oscillation output of ultrasonic wave, and an ultrasonic horn 103 for providing ultrasonic vibration to the capillary. The wire bonding device 1 allows the wire being bonded to a coupling terminal 104 via ultrasonic vibration. The ultrasonic oscillation unit 110 and the ultrasonic horn 103 constitute an ultrasonic wave-applying unit.

The wire bonding device 1 also includes a Z-axis control substrate (movement control unit) 113, a Z-encoder (Z-axis position detecting unit) 105, a calculating unit 106, a storage unit 107, an electrical non-stick detecting unit 108 (“non-stick detecting unit” in FIG. 1), and a judging/correction unit 109. The Z-axis control substrate 113 detects Z-axis moving speed of the capillary 101 in a predetermined bonding position on the coupling terminal 104, and controls the Z-axis movement of the capillary provided by the moving mechanism 102 if the Z-axis moving speed of the capillary 101 is equal to or lower than a predetermined threshold. The Z-encoder 105 detects the Z-axis position of the capillary 101 in the aforementioned bonding position. The calculating unit 106 calculates a displacement in the Z-axis position after the Z-axis moving speed obtained by the Z-axis control substrate 113 reaches equal to or lower than the threshold on the basis of time-dependent change of the Z-axis position of the capillary 101. The storage unit 107 stores the displacement occurred when the wire is bonded to the coupling terminal 104 as an amount of reference displacement.

The electrical non-stick detecting unit 108 detects a non-stick of the wire on the basis of a conducting condition between the wire and the workpiece. The electrical non-stick detecting unit 108 detects a non-stick of the wire on the basis of a conducting condition between the wire and the coupling terminal 104. The judging/correction unit 109 for judging whether a difference between the reference displacement and the displacement when the electrical non-stick detecting unit 108 detects a non-stick in the wire is within a predetermined range or not. One of the threshold and the oscillation output of the ultrasonic wave is corrected if it is judged that a difference between the reference displacement and the displacement when a non-stick of the wire is detected by the electrical non-stick detecting unit 108 is out of a predetermined range.

The wire bonding device 1 will be described in detail below.

A thermosonic bonding system for joining the coupling terminal 104 with a wire or a joint member (metal ball) formed in the tip of the wire by applying ultrasonic vibration, pressure and heat is adopted for the wire bonding device 1. The wire bonding device 1 is employed in an assembly process for the semiconductor device.

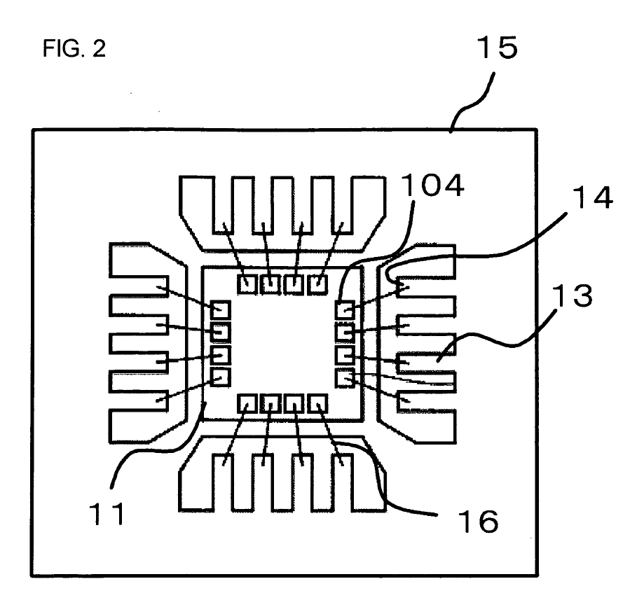

More specifically, the wire bonding device 1 is employed in the wire bonding operation for coupling the semiconductor chip 11 with the lead frame 12 with wires. The wire bonding operation couples the coupling terminals 104 of the semiconductor chip 11 with lead terminals 14 of inner leads 13 as shown in FIG. 2. The coupling terminals 104 are formed in the semiconductor chip 11. Portions of the semiconductor device 10 shown in FIG. 1 constitute a workpiece 15 shown in FIG. 2.

A gold wire may be, for example, employed for the wire 16. A joint member such as a metal ball or the like may be formed in the tip of the wire, which is inserted in the capillary 101.

Returning to FIG. 1, the wire bonding device 1 includes an ultrasonic controller 111. Under a control of the ultrasonic controller 111, the ultrasonic oscillation unit 110 applies oscillation output of ultrasonic wave to the ultrasonic horn 103, and oscillatively emitted ultrasonic wave transmits the inside of the ultrasonic horn 103. This allows providing ultrasonic vibration to the capillary 101 from the ultrasonic horn 103.

The wire bonding device 1 also includes a heater block 112. The semiconductor device 10 is disposed on the heater block 112. The semiconductor device 10 is composed of a substrate (not shown) and a semiconductor chip 11 disposed on the substrate. A lead frame 12 is formed in the substrate. The semiconductor chip 11 is also provided with the coupling terminals 104 formed therein, and the lead terminals 14 are formed in the lead frame 12. Therefore, the semiconductor device 10 is disposed on the heater block 112, so that a certain amount of heat can be applied to the coupling terminals 104 and the lead terminals 14.

In such case, the electrical non-stick detecting unit 108 detects a non-stick of the wire via the electrical technique as will be discussed later. More specifically, an electric current is flowed through the wire, and if an electric current is detected between the wire and the coupling terminal 104, it is judged that wire is suitably joined to the coupling terminal 104. On the other hand, if no electric current is not detected even if an electric current is applied to the wire, it is judged to be a non-stick. In order to detect the conducting condition between the wire and the coupling terminal 104, for example, a potential applied to the coupling terminal 104 is compared with a grounding potential serving as a reference potential, so that the difference therebetween may be detected as a voltage.

A chart containing a condition of the application of ultrasonic wave and a Z-axis real trajectory, which are associated with a time axis, is stored in the storage unit 107. The oscillation output oscillated by the ultrasonic oscillation unit 110 and the output timing of ultrasonic wave, serving as the condition for the application of ultrasonic wave, are stored in the storage unit 107 by the ultrasonic controller 111. On the other hand, the detected Z-position detected by the Z-encoder 105 serving as the Z-axis real trajectory is stored in the storage unit 107 by the Z-axis control substrate 113.

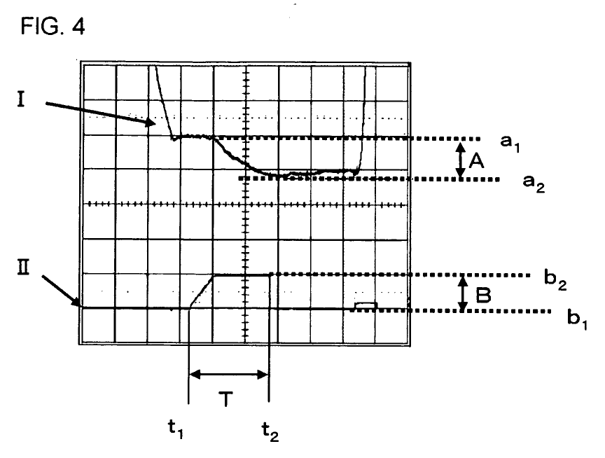

FIG. 4 illustrates a chart (monitoring data) stored in the storage unit 107. Waveform I shows time-dependent change of the Z-axis position detected by the Z-encoder 105. Waveform II shows time-dependent change of the oscillation output of ultrasonic vibration output by the ultrasonic oscillation unit 110. Abscissa represents a time axis in FIG. 4. The Z-axis movement of the capillary 101 and the wire bonding process will be described below in reference to FIG. 4.

A sequence of operations in the wire bonding process is started by moving the capillary 101 by the moving mechanism 102 to cause the wire in contact with the coupling terminal 104. The moving mechanism 102 once moves the capillary 101 to a predetermined X-Y position over the coupling terminal 104, and then moves the capillary 101 downward along Z-axis direction. Then, the contact of the wire with the coupling terminal 104 gradually reduces the downward speed, and when the downward speed reaches to a predetermined threshold, the capillary 101 is maintained in the Z-axis position indicated by a₁. The threshold is configured in the Z-axis control substrate 113 in advance.

Subsequently, according to the condition that the downward speed is equal to or lower than the threshold, the Z-axis control substrate 113 controls the Z-axis movement of the moving mechanism 102 to have a constant speed, so that a constant load is exerted between the capillary 101 and the coupling terminal 104. Then, ultrasonic wave is oscillatively emitted from the ultrasonic oscillation unit 110. In the exemplary implementation shown in FIG. 4, the emission of ultrasonic vibration is started at a timing of t₁, and the emission of ultrasonic vibration is continued for a predetermined term (T). In addition to above, the term (T) for providing ultrasonic vibration is previously stored in the storage unit 107.

Emitted ultrasonic vibration is transmitted through the ultrasonic horn 103 to be provided to the capillary 101. Then, a distortion of the tip of the wire or a joint member of a metal ball formed in the tip of the wire is occurred, so that the Z-axis position of the capillary 101 is gradually moved downward. The Z-encoder 105 detects such change of the Z-axis position over time, and the detected positions are accumulated in the storage unit 107 via the Z-axis control substrate 113. This allows obtaining the chart shown by the waveform I. In the exemplary implementation of FIG. 4, the Z-axis position of capillary 101 is changed from a₁ to a₂.

Then, after a predetermined term (T) is passed, the ultrasonic oscillation unit 110 stops the output of the oscillation of ultrasonic wave at a timing of t₂. Subsequently, the capillary 101 is moved to the lead terminals 14 in X, Y and Z directions (three-dimensionally) by the moving mechanism 102, and the wires are bonded to the lead terminals 14 to provide couplings between the coupling terminals 104 and the lead terminals 14.

Here, the calculating unit 106 may calculate the displacement (A) of the Z-axis position and the oscillation output (B) of ultrasonic wave on the basis of the chart prepared in a sequence of wire bonding operations. The displacement (A) of the Z-axis position may be, in other words, an amount of a depression of the capillary 101 due to a distortion of the tip of the wire caused by ultrasonic wave. In FIG. 4, the displacement (A) of the Z-axis position may be calculated on the basis of a difference between a Z-axis position (a₁) on the occasion that the downward speed of the capillary 101 reaches a threshold and a Z-axis position (a₂) after a predetermined term (T) is passed. The oscillation output (B) of ultrasonic wave may also be calculated with a difference between an electric potential (b₁) in a base condition without applying ultrasonic wave and an electric potential (b₂) applied when the oscillation of ultrasonic wave is conducted to achieve a plateau. The calculating unit 106 may also allow storing the calculated displacement in the Z-axis position and/or the calculated oscillation output in the storage unit 107.

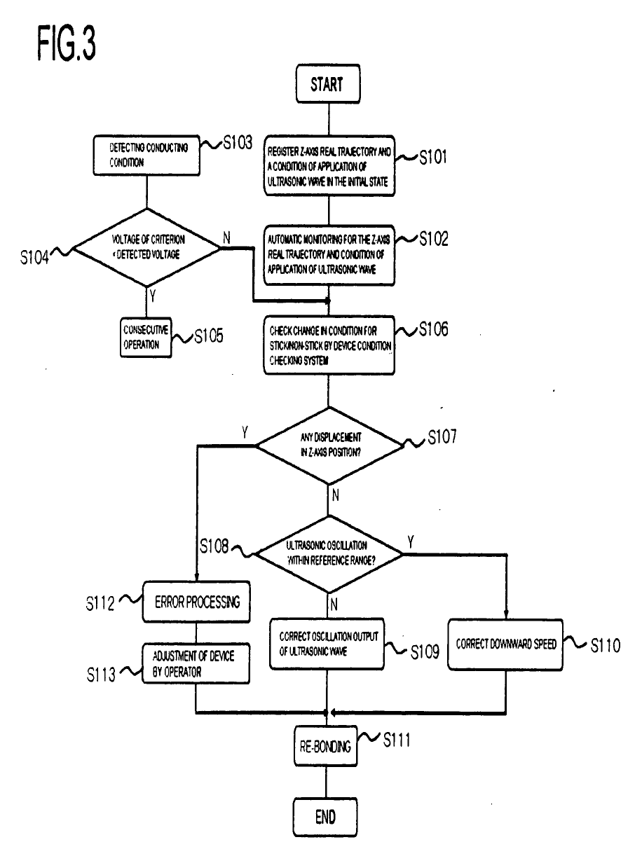

The wire bonding process employing the wire bonding device 1 will be described as follows. FIG. 3 is a flow chart, which is useful in describing a wire bonding process employing the wire bonding device 1.

First of all, a registration of a Z-axis real trajectory and a condition of application of ultrasonic wave in the initial state is accepted, and is stored in the storage unit 107 (S101). More specifically, for example, a chart in the condition that better wire bonding is created as shown in FIG. 4 is registered as system information for the initial state. On this occasion, the calculating unit 106 calculates a displacement (A) of Z-axis position as a reference displacement, and the calculated displacement is stored in the storage unit 107. The calculating unit 106 also calculates an oscillation output (B) of ultrasonic wave as a reference output, and the calculated output is stored in the storage unit 107.

Subsequently, the capillary 101 is moved to a predetermined XY-axis location on a workpiece by the moving mechanism 102, and an automatic monitoring for the Z-axis real trajectory and the condition of application of ultrasonic wave is started by the Z-encoder 105 and the ultrasonic oscillation unit 110a (S102). When the coupling terminal 104 is in contact with the wire to cause that the Z-axis movement is equal to or lower than a predetermined threshold, and a certain load is applied to the capillary 101 and the coupling terminal 104 while the Z-axis control substrate 113 controls the moving speed of the moving mechanism 102 to be constant. When the device is normally operated, ultrasonic wave is output for certain term by the ultrasonic oscillation unit 110 to provide ultrasonic wave to the capillary 101. After the output of ultrasonic wave is stopped, the operation of the moving mechanism 102 is re-started to move the capillary 101 toward X, Y and Z directions from the position of the coupling terminal 104.

In the next, the electrical non-stick detecting unit 108 controls to apply an electric current to the wire, and the conducting condition between the wire and the coupling terminal 104 is detected (S103). In such case, for example, a potential applied to the coupling terminal 104 is compared with a grounding potential serving as a reference potential, so that the difference therebetween may be detected as a voltage. When the detected voltage is larger than a voltage of a criterion (S104Y), it is judged that the bonding is successfully conducted. In such case, the moving mechanism 102 moves the capillary 101 to the above of the lead terminal 14, and the bonding process is conducted on the lead terminal 14. Then, the consecutive operation of the wire bonding device 1 is carried out (S105) to achieve the wire bonding for all of the coupling terminals 104 and the lead terminals 14 in the semiconductor device 10.

On the other hand, when the detected voltage is equal to or lower than the predetermined reference voltage (S104N), it is determined that no electric current is applied between the wire and the coupling terminal 104. This allows detecting that the wire is not bonded to the coupling terminal 104. Once the non-stick of the wire is detected through the electrical technique by the electrical non-stick detecting unit 108 in this way, the electrical non-stick detecting unit sends information for detecting the non-stick to the storage unit 107. The storage unit 107 accepts the information for detecting the non-stick from the electrical non-stick detecting unit 108 and then sends results of automatic monitoring to the calculating unit 106. The calculating unit 106, in turn, calculates the displacement in the Z-axis position (measured displacement) on the basis of the accepted results of the automatic monitoring.

Then, the judging/correction unit 109 refers the storage unit 107 to judge whether the difference between the calculated measured displacement and the stored reference displacement is within a predetermined range or not (S107). The predetermined range is a numerical range, which is previously registered in the storage unit 107. When it is judged that the difference between the calculated measured displacement and the stored reference displacement does not reach the predetermined range (S107N), it is considered that the tip of the wire is not suitably melted due to insufficient application of ultrasonic wave over the tip of the wire, so that a sufficient depression toward the Z-axis direction is not occurred in the capillary 101.

In such case, the calculating unit 106 calculates an oscillation output of ultrasonic wave on the basis of the waveform of the applied ultrasonic wave, and the calculated oscillation output is compared with the reference output, and the difference therebetween is detected. Then, the judging/correction unit 109 judges whether the level of the ultrasonic oscillation at a level comparable with the reference output is applied to the capillary 101 or not, on the basis of the detected difference (S108).

For example, when it is judged that the difference between the measured displacement calculated with the monitoring results and the reference displacement does not reach the predetermined range (S108N), and when the oscillation output does not reach the reference output, the judging/correction unit 109 provides an automatic correction for the ultrasonic controller unit 111, which instructs the ultrasonic oscillation unit 110 to increase the oscillation output (S109). This allows increasing the ultrasonic vibration applied to the capillary 101. On the other hand, when then oscillation output is larger than the reference output, the judging/correction unit 109 provides an automatic correction, which allows decreasing the oscillation output of ultrasonic wave from the ultrasonic oscillation unit 110 (S109). This allows reducing the ultrasonic vibration applied to the capillary 101.

Besides, when it is judged that the oscillation output calculated with the monitoring results falls within the predetermined range of the reference output (S108Y), it is considered that the wire is not in suitable contact with the coupling terminal 104. Then, the judging/correction unit 109 increases or decreases a threshold for the downward speed, which is previously provided for the Z-axis control substrate 113 (S110).

This allows achieving an adequate contact of the coupling terminal 104 with the wire tip or the metallic ball formed at the wire tip. In addition, when the metallic ball is formed at the wire tip, the configuration also prevents an excessive destroy of the metallic ball due to excessive falling of the capillary 101.

After the automatic corrections are conducted for the Z-axis control substrate 113 and the ultrasonic controller unit 111 by the judging/correction unit 109 as described above, the bonding process over the coupling terminal 104 is conducted again (S111).

Meanwhile, when the judging/correction unit 109 judges that the measured displacement satisfies the reference displacement (S107Y), it is considered that an unexpected error is occurred. Various types of errors are considered as the unexpected error, and it is considered that the possible cause for the error is in, for example, the semiconductor device 10 or the like, and not in the wire bonding device 1. Thus, the wire bonding device 1 conducts an error processing by displaying an error message on a monitor or by calling with an alarm (S112), and then an adjustment of the device is conducted by an operator (S113). Then, after a recovery process is conducted, a re-bonding process is conducted (S111).

Next, advantageous effects obtainable by employing the configuration of the wire bonding device 1 will be described in reference to FIG. 1. According to the configuration of the wire bonding device 1, the time-variation of the Z-axis position of capillary 101 is detected at the predetermined bonding position on the coupling terminal 104 when the moving of the capillary 101 along the Z-axis is controlled by the Z-axis control substrate 113, and a judgment on whether a difference between the reference displacement and the displacement in the Z-axis position of the capillary 101 when a non-stick of the wire is detected by the electrical technique falls within the predetermined range or not is achieved. This allows detecting an occurrence of a melting of the wire tip due to ultrasonic wave, in addition to detecting a conducting condition between the wire and the coupling terminal 104, achieving a detection of the non-stick of the wire with an improved accuracy.

In addition, according to the configuration of the wire bonding device 1, the judging/correction unit 109 is capable of judging the displacement in the Z-axis position and the condition of the application of ultrasonic wave, which are possible causes for a non-stick. Then, the storage unit 107 previously stores the displacement in the Z-axis position and the timing for applying ultrasonic wave and/or the oscillation output, so that data of the Z-axis position of the capillary 101 detected by the Z encoder 105 and the ultrasonic oscillation output data from the ultrasonic oscillation unit 110 is utilized, in addition to detecting the conducting condition between the wire and the coupling terminal 104, so that the judging/correction unit 109 can detect the melting via ultrasonic wave to specify the factor of the wire non-stick. In addition, the judging/correction unit 109 derives a precise correction factor on the basis of the oscillation output of ultrasonic wave in the initial state as a reference to increase or decrease the oscillation output with such correction factor, so that a proper amount of ultrasonic vibration can be provided to the capillary 101.

In addition, if the judging/correction unit 109 judges that output of ultrasonic wave at a level comparable with the initial state is achieved though no depression of the capillary 101 is detected, it is specified that no contact of the wire with the coupling terminal 104 is the cause of the non-stick. Therefore, the timing of detection for the downward speed in the Z-axis control substrate 113 is suitably controlled to create a suitable contact between the wire and the coupling terminal 104.

As described above, according to the wire bonding device 1, a possible cause for a non-stick can be automatically specified to provide an easy automatic correction within the bonding device. Therefore, the adjustment of the device can be conducted without relying upon the skill of the operator, so that a recovery of the device from the wire non-stick is easily achieved. In addition, an automatic correction is conducted within the device, so that an easy recovery can be achieved without stopping the operation of the device on any occasion. Therefore, a decrease in the throughput of the manufacturing process due to the stopping of the operation of the device can be controlled.

While the preferred embodiments of the present invention have been described above in reference to the annexed figures, it should be understood that the disclosures above are presented for the purpose of illustrating the present invention, and various modifications other than that described above are also available.

It is apparent that the present invention is not limited to the above embodiment, and may be modified and changed without departing from the scope and spirit of the invention.

What a claimed is:

1. A wire bonding device, comprising:
a capillary, containing a wire inserted therethrough; a moving mechanism for moving said capillary for X, Y, and Z directions;
an ultrasonic wave-applying unit for oscillatively generating ultrasonic wave to apply ultrasonic vibration to said capillary;
a movement control unit for detecting Z-axis moving speed of said capillary in a predetermined bonding position on a work, and then controlling Z-axis movement of said capillary with said moving mechanism when the Z-axis moving speed of said capillary is equal to or lower than a predetermined threshold;
a Z-axis position detecting unit for detecting Z-axis position of said capillary in the bonding position;
a calculating unit for calculating a displacement in the Z-axis position after the Z-axis moving speed obtained by said movement control unit reaches equal to or lower than the threshold on the basis of time-dependent change of the Z-axis position of said capillary;
a storage unit for storing the displacement occurred when said wire is bonded to said workpiece, as a reference displacement;
an electrical non-stick detecting unit for detecting a non-stick of said wire on the basis of a conducting condition between said wire and said workpiece;
a judging unit for judging whether a difference between the reference displacement and the displacement when a non-stick of said wire is detected by said electrical non-stick detecting unit is within a predetermined range or not; and
a correction unit for correcting any one of the threshold and the oscillation output of the ultrasonic wave if said judging unit judges that a difference between the reference displacement and the displacement when a non-stick of said wire is detected by said electrical non-stick detecting unit is out of a predetermined range.

2. The wire bonding device as set forth in claim 1, wherein said correction unit increases the oscillation output of the ultrasonic wave, if said judging unit judges that the difference between the reference displacement and the displacement when a non-stick of said wire is detected by said electrical non-stick detecting unit is out of a predetermined range.

3. The wire bonding device as set forth in claim 1, wherein said correction unit reduces the oscillation output of the ultrasonic wave, if said judging unit judges that the difference between the reference displacement and the displacement when a non-stick of said wire is detected is out of a predetermined range.

4. The wire bonding device as set forth in claim 1, wherein said storage unit stores the oscillation output of the ultrasonic wave when said wire is bonded to said workpiece, as a reference output,
wherein said calculating unit detects a difference between the reference output and the oscillation output when said electrical non-stick detecting unit detects a non-stick of said wire, said judging unit judges whether a predetermined level of ultrasonic wave is provided to said capillary or not, on the basis of the difference between the reference output and the oscillation output when said electrical non-stick detecting unit detects a non-stick of said wire, and
wherein said correction unit controls the oscillation output of the ultrasonic wave when said judging unit judges that a predetermined level of ultrasonic wave is not provided to said capillary.

5. The wire bonding device as set forth in claim 1, wherein said correction unit corrects the threshold, if said judging unit judges that the difference between the reference displacement and the displacement when a non-stick of said wire is detected is out of a predetermined range.

6. The wire bonding device as set forth in claim 1, further comprising an error output unit for outputting an error, if said judging unit judges that the difference between the reference displacement and the displacement when a non-stick of said wire is detected is within a predetermined range.

7. A wire bonding process, comprising:
inserting a wire in a capillary;
moving said capillary for X, Y, and Z directions;
oscillatively generating ultrasonic wave to apply ultrasonic vibration to said capillary;
detecting Z-axis moving speed of said capillary in a predetermined bonding position on a workpiece and controlling the Z-axis movement of said capillary if the Z-axis moving speed of said capillary is equal to or lower than a predetermined threshold;
detecting the Z-axis position of said capillary in the bonding position;
calculating a displacement in the Z-axis position after the Z-axis moving speed of said capillary reaches equal to or lower than the threshold on the basis of time-dependent change of the Z-axis position of said capillary;
storing the displacement occurred when said wire is bonded to said workpiece, as a reference displacement;
detecting a non-stick of said wire on the basis of a conducting condition between said wire and said workpiece;
judging whether a difference between the reference displacement and the displacement when a non-stick of said wire is detected on the basis of the conducting condition is within a predetermined range or not; and
correcting any one of the threshold and the oscillation output of the ultrasonic wave if it is judged that a difference between the reference displacement and the displacement when a non-stick of said wire is detected is out of a predetermined range.
